(19) United States
(12) Patent Application Publication
(10) Pub. No.: US 2022/0179899 A1
(43) Pub. Date: Jun. 9, 2022

(54) INFORMATION PROCESSING APPARATUS, SEARCH METHOD, AND NON-TRANSITORY COMPUTER READABLE MEDIUM STORING PROGRAM

(71) Applicant: NEC Corporation, Minato-ku, Tokyo (JP)

(72) Inventor: Tingting DONG, Tokyo (JP)

(73) Assignee: NEC Corporation, Minato-ku, Tokyo (JP)

(21) Appl. No.: 17/436,299

(22) PCT Filed: Dec. 17, 2019
(86) PCT No.: PCT/JP2019/049299

§ 371 Date: Sep. 3, 2021

(30) Foreign Application Priority Data
Mar. 20, 2019 (JP) 2019-053045

(51) Int. Cl. G06F 16/532; G06V 10/94; G06F 16/538; G06F 16/583

(52) U.S. Cl. CPC G06F 16/532; G06F 16/583; G06F 16/538; G06V 10/945

(57) ABSTRACT

An information processing apparatus includes a search condition acquisition unit that acquires an input search condition, an image display unit that displays at least one type of an image of an object designated by the search condition acquired by the search condition acquisition unit, the at least one type of the image representing a variation of the object or a variation of an aspect designated by the search condition for the object, a selection receiving unit—that receives an instruction for selecting at least one type of an image from among the images displayed by the image display unit, and a search condition determination unit that determines a search condition based on the image selected according to the instruction received by the selection receiving unit.

### TECHNICAL FIELD

The present invention relates to an information processing apparatus, a search method, and a program.

### BACKGROUND ART

In recent years, as camera devices such as smartphones and security cameras have become widespread, there has been a growing demand for searches for images the number of which has been significantly increasing. In this regard, techniques for searching for images have been proposed.

For example, Patent Literature 1 discloses a technique for generating search conditions from a search key image and searching for an image in order to reduce a burden on a user of inputting search conditions such as features and shooting conditions. In this technique, a plurality of search conditions different from each other are generated based on feature values or shooting conditions acquired from the search key image. After that, in this technique, images that exactly meet or roughly meet each of the search conditions are retrieved and the result of the retrieval is shown to the user. The user selects an image from the shown search result and sets the selected image as a new search key image. In this way, the search is repeated so that an image satisfying the features or the shooting conditions intended by the user is found.

Further, Patent Literature 2 discloses a technique for searching for a part having a color, or a color and a shape designated by a user from an image of a subject displayed on a monitor screen of an electronic apparatus. Further, in this technique, a search result is displayed in such a manner that only a part that meets the designated conditions is displayed, or parts other than the aforementioned part are displayed in a semi-transparent manner.

Further, in addition to the technique for searching for an image, various techniques for generating images have been proposed. For example, Non-patent Literature 1 discloses a technique for generating a realistic image that conforms to text input by a user by using a machine learning technique. The purpose of this technique is to generate an image faithful to the text.

### CITATION LIST

### Patent Literature

Patent Literature 1: Japanese Unexamined Patent Application Publication No. 2011-164799
Patent Literature 2: Japanese Unexamined Patent Application Publication No. 2005-18628

### Non Patent Literature

Non-patent Literature 1: Z. Zhang, Y. Xie, L. Yang, “Photographic Text-to-Image Synthesis with a Hierarchically-nested Adversarial Network”, The IEEE Conference on Computer Vision and Pattern Recognition (CVPR), Jun. 2018.

### SUMMARY OF INVENTION

### Technical Problem

In order to appropriately search for an image, it is important to appropriately acquire search conditions intended by a user.

It is assumed that, for example, an image of a person wearing red clothes is searched for in a data set containing a number of images of persons. When there are a large number of images of persons wearing red clothes in the data set, it is important to further narrow down the conditions in regard to the “red clothes”. More specifically, it is desired to narrow down the search conditions intended by the user by making the user select whether the “red” is bright red or pinkish red, and select whether the “red clothes” means that the user is dressed in red on his/her entire body or dressed in red only on his/her upper body. It is possible to reduce the number of images obtained as a search result by narrowing down the search conditions. Further, it has an effect of reducing the time and trouble that the user takes to check the result images in addition to increasing the speed of the search process. That is, there has been a demand for a technique for determining search conditions in which a user's intention is taken into consideration in detail.

In the technique disclosed in Patent Literature 1, when performing a search, a user selects only a search key image and does not enter any information about a specific search target to the apparatus. Therefore, it is impossible to determine search conditions in which a user's intention is taken into consideration in detail.

Meanwhile, in Patent Literature 2, when a part whose color or shape matches the color or shape designated by a user is searched for, the user's intention for the search is not checked in a more detailed manner. Therefore, in this technique, it is impossible to determine search conditions in which a user's intention is taken into consideration in detail.

Non-patent Literature 1 discloses a technique for generating a high-quality image that meets conditions specified by a user, and it is impossible to determine search conditions in which a user's intention is taken into consideration in detail.

Therefore, one of objects of example embodiments disclosed in this specification is to provide an information processing apparatus, a search method, and a program capable of determining search conditions in which a user's intention is taken into consideration in detail.

### Solution to Problem

An information processing apparatus according to a first aspect include:

search condition acquisition means for acquiring an input search condition;

image display means for displaying at least one type of an image of an object designated by the search condition acquired by the search condition acquisition means, the at least one type of the image representing a variation of the object or a variation of an aspect designated by the search condition for the object;

selection receiving means for receiving an instruction for selecting at least one type of an image from among the images displayed by the image display means; and search condition determination means for determining a search condition based on the image selected according to the instruction received by the selection receiving means.

A search method according to a second aspect includes:

acquiring an input search condition;

displaying at least one type of an image of an object designated by the acquired search condition, the at least one type of the image representing a variation of the object or a variation of an aspect designated by the search condition for the object;

receiving an instruction for selecting at least one type of an image from among the displayed images; and

determining a search condition based on the image selected according to the received instruction.

A program according to a third aspect causes a computer to perform:

a search condition acquisition step of acquiring an input search condition;

an image display step of displaying at least one type of an image of an object designated by the acquired search condition, the at least one type of the image representing a variation of the object or a variation of an aspect designated by the search condition for the object;

a selection receiving step of receiving an instruction for selecting at least one type of an image from among the displayed images; and

a search condition determination step of determining a search condition based on the image selected according to the received instruction.

### Advantageous Effects of Invention

According to the above-described aspect, it is possible to provide an information processing apparatus, a search method, and a program capable of determining search conditions in which a user's intention is taken into consideration in detail.

### BRIEF DESCRIPTION OF DRAWINGS

FIG. 1 is a block diagram showing an example of a configuration of an information processing apparatus according to an outline of an example embodiment;

FIG. 2 is a block diagram showing an example of a configuration of an information processing apparatus according to an example embodiment;

FIG. 3 is a schematic diagram showing an example of thesaurus information about an object;

FIG. 4 is a schematic diagram showing an example of thesaurus information in regard to the color of the object;

FIG. 5 is a schematic diagram showing an example of thesaurus information in regard to the location of the object;

FIG. 6 is a schematic diagram showing an example of thesaurus information in regard to the orientation of the object;

FIG. 7 is a schematic diagram showing an example of thesaurus information in regard to the movement of the object;

FIG. 8 is a block diagram showing an example of a hardware configuration of an information processing apparatus according to an example embodiment;

FIG. 9 is a flowchart showing a flow of operations performed by an information processing apparatus according to an example embodiment;

FIG. 10 is a schematic diagram showing a flow of an example of a search in an image in which persons are shown;

FIG. 11 is a table showing an example of search conditions determined by a search condition determination unit;

FIG. 12 is a schematic diagram showing a flow of an example of a search in an image in which a car is shown; and

FIG. 13 is a table showing an example of search conditions determined by a search condition determination unit.

### DESCRIPTION OF EMBODIMENTS

### Outline of Example Embodiment

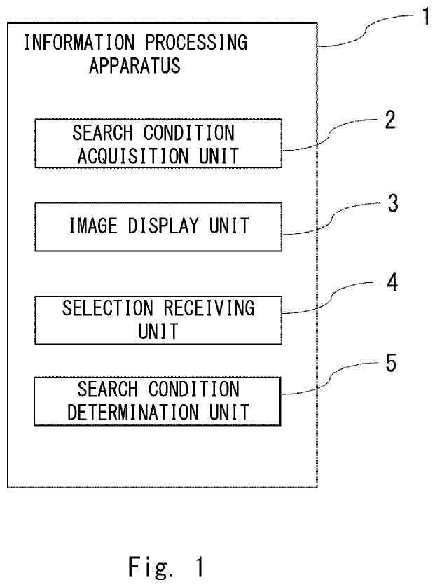

Prior to giving the detailed description of an example embodiment, an outline of the example embodiment will be described. FIG. 1 is a block diagram showing an example of a configuration of an information processing apparatus 1 according to an outline of an example embodiment. As shown in FIG. 1, the information processing apparatus 1 includes a search condition acquisition unit 2, an image display unit 3, a selection receiving unit 4, and a search condition determination unit 5.

The search condition acquisition unit 2 acquires a search condition(s) input to the information processing apparatus 1. The search condition acquired by the search condition acquisition unit 2 is, for example, a search condition(s) input by a user. This search condition designates at least a search target object. Further, the search condition may designate, in addition to the search target object, an aspect(s) of the object (e.g., a color, a position, an orientation, a movement, and the like of the object). The information processing apparatus 1 does not use the search condition acquired by the search condition acquisition unit 2 for the search process as it is, but instead determines search conditions in which a user's intention is taken into consideration in a more detailed manner than the search condition acquired by the search condition acquisition unit 2 by using the search condition determination unit 5.

The image display unit 3 displays, on a display, at least one type of an image of the object designated by the search condition acquired by the search condition acquisition unit 2, representing a variation of the object or a variation of the aspect designated by the search condition for the object. For example, when the search target object designated by the search condition acquired by the search condition acquisition unit 2 is a “Car”, the image display unit 3 displays at least one type of an image representing a variation of the car. More specifically, for example, the image display unit 3 displays an image of a normal-sized car, an image of a compact car, an image of a bus, and the like. In the following description, an image representing a variation may also be simply referred to as a variation image.

The selection receiving unit 4 receives an instruction for selecting at least one type of an image from among the images displayed by the image display unit 3. The user, who has input the search condition, selects an image in which his/her intention is taken into consideration from among the displayed images. This selection is received by the selection receiving unit 4.

The search condition determination unit 5 determines search conditions based on the image selected according to the instruction received by the selection receiving unit 4. That is, the search condition determination unit 5 uses the search conditions corresponding to the contents of the selected image as search conditions used for the search process.

As described above, the information processing apparatus 1 displays variation images and receives user's selection for the variation images. Then, the search conditions are determined according to the selection. Therefore, it is possible to determine search conditions in which a user's intention is taken into consideration in detail.

### Details of Example Embodiment

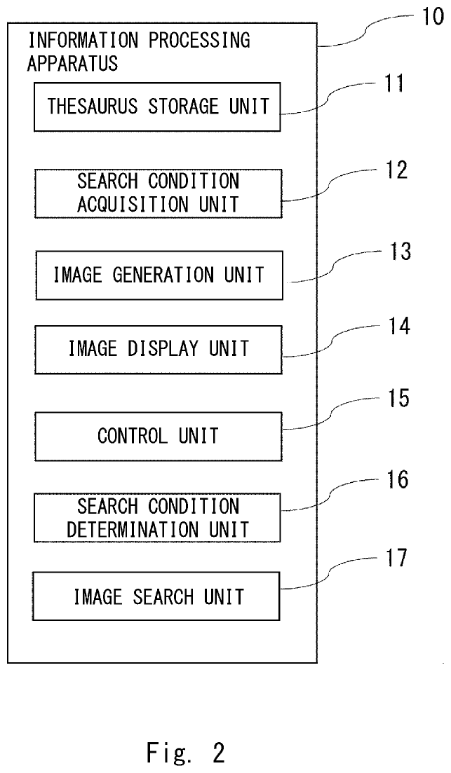

Next, details of an example embodiment will be described. FIG. 2 is a block diagram showing an example of a configuration of an information processing apparatus 10 according to the example embodiment. As shown in FIG. 2, the information processing apparatus 10 includes a thesaurus storage unit 11, a search condition acquisition unit 12, an image generation unit 13, an image display unit 14, a control unit 15, a search condition determination unit 16, and an image search unit 17.

The thesaurus storage unit 11 stores information in which keywords that could be used for a search are systematically collected (i.e., organized) in advance. In the following description, this information will be referred to as thesaurus information. The thesaurus information is, for example, information having a tree structure showing a relation between a keyword having a broader concept and keywords having narrower concepts. In this example embodiment, the thesaurus storage unit 11 stores thesaurus information in regard to an object and thesaurus information in regard to aspects of the object.

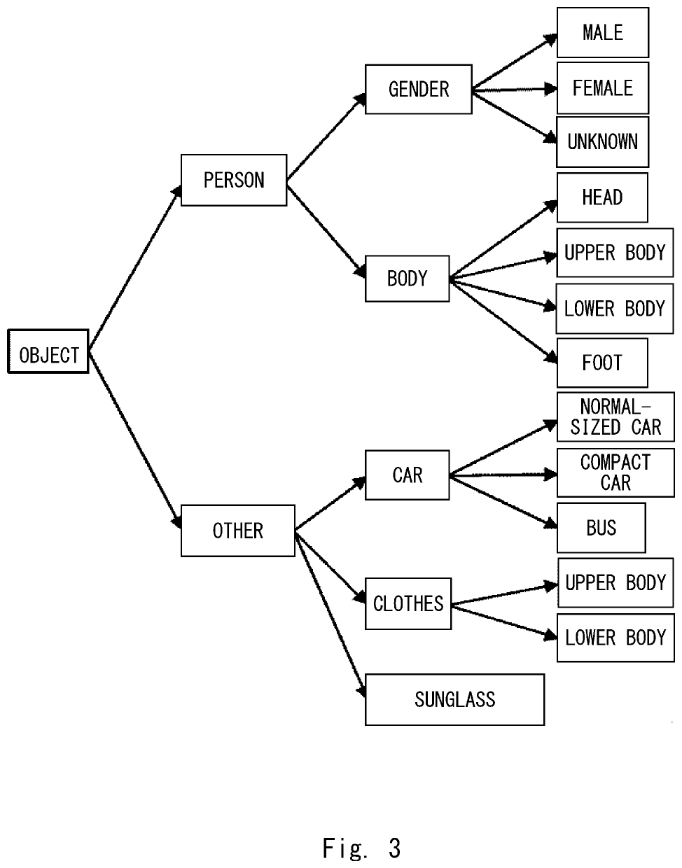

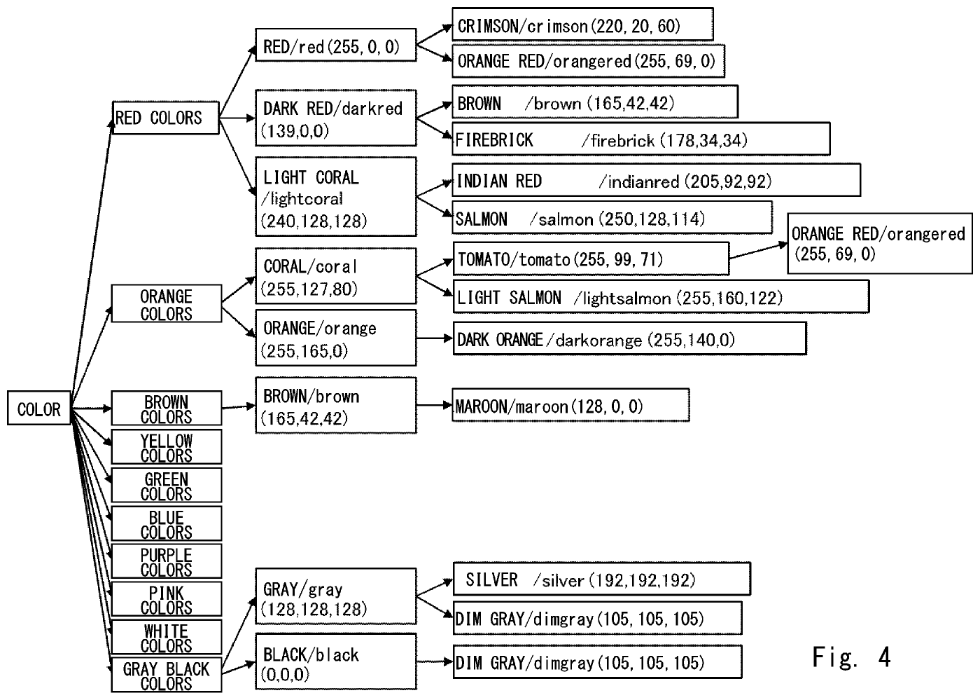

FIG. 3 is a schematic diagram showing an example of thesaurus information in regard to an object. Each of FIGS. 4 to 7 is a schematic diagram showing an example of thesaurus information in regard to an aspect of the object. The thesaurus information shown in each of FIGS. 3 to 7 has such a structure that an association of a keyword having a broader concept with keywords for classifying the keyword having the broader concept is repeated in a hierarchical manner. For example, in the example shown in FIG. 3, concepts (keywords) “Person” and “Other” are associated with a concept (a keyword) “Object”. Further, regarding the “Person”, concepts (keywords) “Male”, “Female”, and “Unknown” are associated thereto.

FIG. 4 is a schematic diagram showing an example of thesaurus information in regard to the color of the object. The known classification of colors may be used for the thesaurus information in regard to the color. As an example of such a classification, FIG. 4 shows a part of “Extended Basic Colors” used in HTML, which is a classification system of 147 colors.

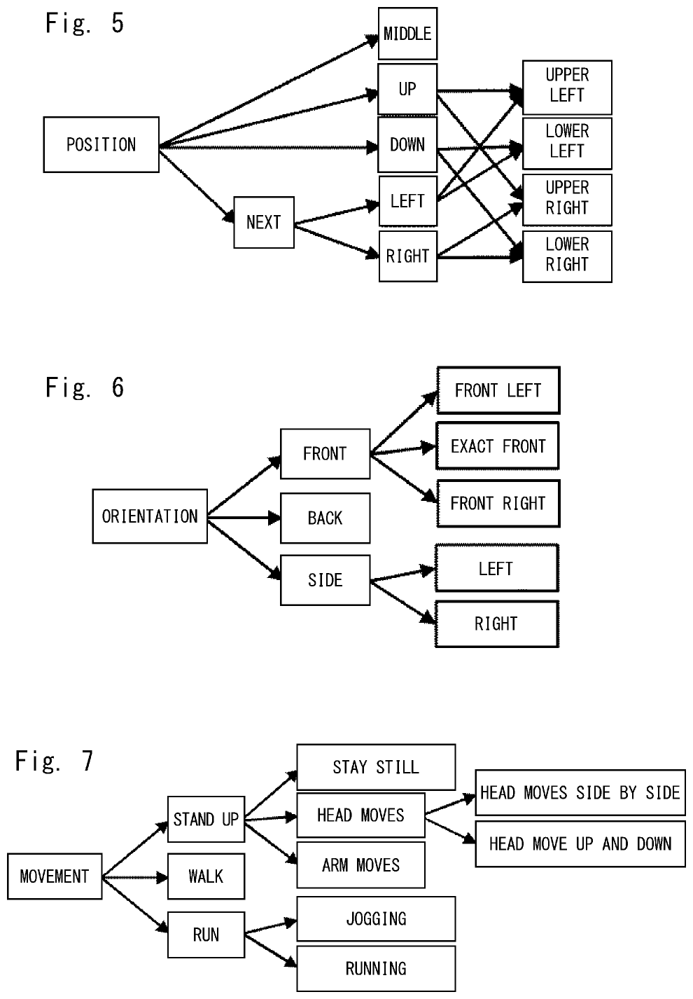

FIG. 5 is a schematic diagram showing an example of thesaurus information in regard to the position of the object. According to the thesaurus information shown in FIG. 5, for example, information in regard to the position expressed as “Next” is classified into “Left” and “Right”. Further, the “Left” is classified into “Upper left” and “Lower left”, and the “Right” is classified into “Upper right” and “Lower right”.

FIG. 6 is a schematic diagram showing an example of thesaurus information in regard to the orientation of the object. According to the thesaurus information shown in FIG. 6, for example, information in regard to the position expressed as “Front” is classified into “Front left” (which is the front, but is in a state in which a left side is slightly seen, rather than being exactly the front) and “Front right” (which is the front, but is in a state in which a right side is slightly seen, rather than being exactly the front).

FIG. 7 is a schematic diagram showing an example of thesaurus information in regard to the movement of the object. According to the thesaurus information shown in FIG. 7, for example, information in regard to the movement expressed as “Stand up” is classified into a movement “Stay still”, a movement “Head moves”, and a movement “Arm moves”. Further, the information in regard to the movement “Head moves” is classified into a movement “Head moves from side to side” and a movement “Head moves up and down”.

The granularity of the classification and the depth of the hierarchy in the thesaurus information may be arbitrarily determined. The thesaurus information may be created by a designer or automatically created based on existing a knowledge base or based on an existing algorithm.

The search condition acquisition unit 12 corresponds to the search condition acquisition unit 2 shown in FIG. 1. The search condition acquisition unit 12 acquires a search condition(s) input by a user. The user designates, as a search condition, an object (i.e., a subject) shown in an image the user wants to retrieve. That is, the search condition acquired by the search condition acquisition unit 12 includes the designation of the search target object. Further, the search condition acquired by the search condition acquisition unit 12 may include the designation of an aspect of the object shown in the image the user wants to retrieve. That is, the search condition acquisition unit 12 acquires, as a search condition, a condition(s) for the subject of the search target image.

The search condition acquisition unit 12 may acquire, as a search condition, text the user has input to the information processing apparatus 10, or a search condition designated by an input method other than the text. For example, a search condition may be acquired based on voice data input to the information processing apparatus 10. In this case, the search condition acquisition unit 12 acquires a search condition by converting the voice data into text by applying a known voice analysis technique to the voice data. Further, the user may also select a choice such as an icon representing a predetermined object or a predetermined aspect. In this case, the search condition acquisition unit 12 acquires a search condition corresponding to the selected choice. For example, the search condition acquisition unit 12 may show text “Person” as one of choices. Then, when this choice is selected by the user, the search condition acquisition unit 12 may acquire the “Person” as a search condition. Further, the search condition acquisition unit 12 may show a figure illustrating a person as one of choices, and when this choice is selected by the user, the search condition acquisition unit 12 may acquire the “Person” as a search condition.

Note that when a search condition is acquired from text, the search condition acquisition unit 12 analyzes the text and extracts information about the search condition by using a known text analysis technique such as syntactic analysis or a morphological analysis. For example, in the case of the morphological analysis, known words are stored in a dictionary in advance, and the text is divided into appropriate word strings by referring to the dictionary. It is possible to add, in the dictionary, a part of speech (i.e., a type of a word such as a noun and a verb), reading (i.e., a phonetical notation), and the like to a word, and thereby to add various information items to the word.

For example, a dictionary in which keywords (words) defined in the thesaurus information stored in the thesaurus storage unit 11 are stored in advance may be used in order to extract a search condition from text. In this case, the search condition acquisition unit 12 acquires a search condition by extracting a word that appears in the dictionary from an input text.

Note that a list of synonyms may be used. The synonym list is data that indicates words having the same meaning as that of a keyword (a word) defined in the thesaurus information. In this case, the search condition acquisition unit 12 can acquire, as a search condition, not only a word defined in the thesaurus information but also its synonymous word(s).

The image generation unit 13 and the image display unit 14 correspond to the image display unit 3 shown in FIG. 1. That is, the image generation unit 13 and the image display unit 14 may be collectively referred to as an image display unit. The image display unit 14 shows an image generated by the image generation unit 13 to the user by displaying the image on a display.

The image generation unit 13 generates an image representing search conditions according to the search conditions acquired by the search condition acquisition unit 12. The image generation unit 13 generates a variation image(s) of the object designated by the search conditions acquired by the search condition acquisition unit 12 or a variation image(s) of an aspect(s) designated by the search conditions acquired by the search condition acquisition unit 12. Specifically, the image generation unit 13 generates a variation image(s) to be displayed as follows.

Firstly, the image generation unit 13 specifies a keyword corresponding to the search conditions acquired by the search condition acquisition unit 12 in the thesaurus information. That is, the image generation unit 13 specifies which keyword defined in the thesaurus information the object designated by the search conditions corresponds to. Further, the image generation unit 13 designates which keyword defined in the thesaurus information the aspect of the object designated by the search conditions corresponds to. Further, the image generation unit 13 generates an image corresponding to the keyword defined in thesaurus information as a narrower concept of the specified keyword. That is, the image generation unit 13 generates an image representing a concept (a keyword) related to the concept (the keyword) designated by the search conditions.

Specifically, the image generation unit 13 generates, for example, images described below. For example, when a “Car” is acquired as a search condition, a “Normal-sized car”, a “Compact car”, and a “Bus” are defined as narrower concepts of the “Car” according to the thesaurus information shown in FIG. 3. Therefore, the image generation unit 13 generates three types of images, i.e., an image of the “Normal-sized car”, an image of the “Compact car”, and an image of the “Bus”.

Note that the image generation unit 13 may generate an image representing the concept itself designated by the search conditions, instead of generating an image of the concept related to the concept designated by the search conditions. For example, when a “Male” is acquired as a search condition, the image generation unit 13 may generate one type of an image representing the “Male”.

The image generation unit 13 may generate only one type of an image, or may generate a plurality of types of images.

When a plurality of keywords (concepts) are included in the search conditions, a variation image(s) may exist for each of the keywords. For example, for search conditions including a “Red” and a “Car”, a variation image(s) for the “Red” can be generated and a variation image(s) for the “Car” can also be generated. In such a case, instead of showing all the variation images to the user, only an image(s) that is selected according to a predetermined priority order may be displayed. For example, the predetermined priority order is an order of the object, the position of the object, the orientation thereof, the color thereof, and the movement thereof.

The order of designation of objects or aspects in the search conditions acquired by the search condition acquisition unit 12 may be used as the priority order. For example, it is conceivable that objects or aspects are designated in descending order of the importance in text of search conditions. In this case, a variation image of an object or an aspect that was designated earlier may be preferentially displayed. Therefore, the image generation unit 13 may preferentially generate a variation image of the object or the aspect that was designated earlier. Further, the image generation unit 13 may generate variation images of all the designated objects or aspects, and the image display unit 14 (which will be described later) may preferentially display, among these images, a variation image of an object or an aspect that was designated earlier.

For example, when search conditions are designated in the order of a “Red” and a “Car”, a variation image for the “Red” is preferentially displayed over a variation image for the “Car”. As described above, the image display unit 14 may determine the priority order of the display of images according to the order of designation of objects or aspects in the search conditions acquired by the search condition acquisition unit 12. According to the above-described configuration, it is possible to preferentially show a variation image of a concept that is considered to be important by the user, so that the user can easily select a variation image in which his/her intention is taken into consideration.

Note that although the content of the image to be generated is determined by using thesaurus information in this example embodiment, the content of the image to be generated may be determined by other methods. For example, a variation image to be generated may be determined by referring to a hierarchical structure of an index that is defined in advance for an image data set in which the search is performed.

Note that a default setting may be used for an aspect(s) that is not designated in the search conditions acquired by the search condition acquisition unit 12. For example, when a “Red car” is acquired as a search condition, aspects in regard to the orientation of the object and the position thereof are not designated in this search condition. In this case, the image generation unit 13 generates an image in which an object having a predetermined orientation is present at a predetermined position in the image. For example, the image generation unit 13 generates an image in which a red car viewed from the front is shown at the center of the image.

When the content of the image to be generated is specified, the image generation unit 13 generates an image corresponding to the content by using an arbitrarily-determined known technique. For example, the image generation unit 13 selects image data that conforms to the content of the image to be generated from a pre-prepared image data group representing keywords defined in the thesaurus information in regard to the object (see FIG. 3). The image data group representing the keywords defined in the thesaurus information in regard to the object includes, for example, image data of a figure representing a car, image data of a figure representing a normal-sized car, image data of a figure representing a compact car, image data of a figure representing a bus, and the like. Note that these image data do not necessarily have to be prepared in advance. That is, the image generation unit 13 may generate an image of the object from a keyword(s) of the object by using a known image generating technique. Then, the image generation unit 13 generates, by using the image data of the object, an image in which the object is shown in an aspect(s) determined based on the search conditions or a default setting. For example, the image generation unit 13 generates an image in which the object is colored in a color determined based on the acquired search conditions or the default setting. Arbitrarily-determined drawing software, including computer graphics software and the like, may be used for the generation of the image.

The generated image may be a still image, or may be a moving image. When the generated image is a moving image, the image generation unit 13 generates the moving image, for example, by combining a plurality of successive still images representing a movement of the object. Examples of the still image include a painting, a figure, clip art, and an illustration, and examples of the moving image include a video image and animation. However, the types of images are not limited to these examples.

Note that the user may designate image data of a drawing created by the user himself/herself by using a drawing tool or the like as a search condition for designating the object. In this case, the image generation unit 13 may generate, by using the image data of the drawing created by the user, an image in which the object is shown in the aspect determined based on the search conditions or the default setting.

The control unit 15 corresponds to the selection receiving unit 4 shown in FIG. 1. The control unit 15 receives, from the user, an instruction for selecting at least one type of an image from among the images displayed by the image display unit 14. Further, the control unit 15 receives, from the user, an instruction for determining search conditions. Further, the control unit 15 performs control processes including control for requesting the user to select an image and control for requesting the user to input a search condition again. The user checks whether or not an image having the content in which the user's intention is taken into consideration is included in the image group displayed by the image display unit 14. Then, when there is the image having the content in which the intention is taken into consideration, the user selects one or a plurality of images each of which has the content in which the intention is taken into consideration. Further, after checking the images displayed by the image display unit 14, the user can input a search condition again. In this way, the image generation process by the image generation unit 13 and the display process by the image display unit 14 are performed again. These processes are repeated until an instruction for determining search conditions is received from the user.

The search condition determination unit 16 corresponds to the search condition determination unit 5 shown in FIG. 1. When an instruction for determining search conditions is received, the search condition determination unit 16 determines search conditions based on the image selected by the instruction for selecting an image received by the control unit 15. That is, the search condition determination unit 16 uses the search conditions corresponding to the content of the selected image as search conditions used for the search process. Specifically, the object and the aspect(s) of the object represented by the selected image are specified as a search target, and the object and the aspect(s) are used as search conditions.

The image search unit 17 searches for an image that meets the search conditions determined by the search condition determination unit 16 according to the search conditions. That is, the image search unit 17 searches for an image that meets the search conditions from the data set of images.

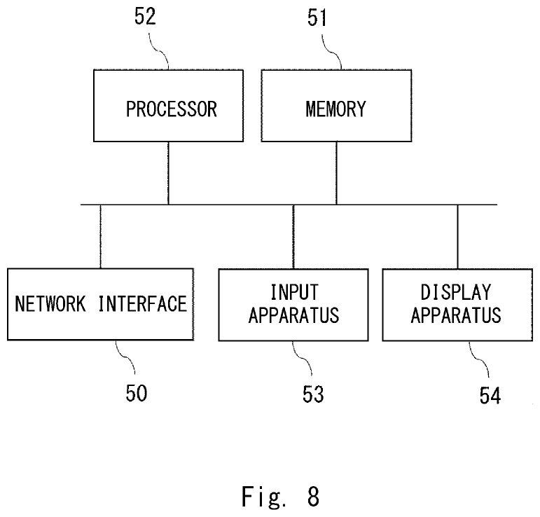

Next, an example of a hardware configuration of the information processing apparatus 10 will be described. FIG. 8 is a block diagram showing an example of the hardware configuration of the information processing apparatus 10.

As shown in FIG. 8, the information processing apparatus 10 includes, for example, a network interface 50, a memory 51, a processor 52, an input device 53, and a display apparatus 54.

The network interface 50 is used to communicate with other apparatuses. For example, the network interface 50 is used when the information processing apparatus 10 receives an input from a user through another apparatus, or when the information processing apparatus 10 shows an image to a user through another apparatus. The network interface 50 may include, for example, a network interface card (NIC).

The memory 51 is formed of, for example, a combination of a volatile memory and a nonvolatile memory. The memory 51 is used to store software (a computer program) and the like including at least one instruction executed by the processor 52.

The program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), a CD-R, and a CD-R/W, and a semiconductor memory (such as a mask ROM, a Programmable ROM (PROM), an Erasable PROM (EPROM), a flash ROM, and a Random Access Memory (RAM)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

The processor 52 may be, for example, a microprocessor, an MPU (Micro Processor Unit), or a CPU (Central Processing Unit). The processor 52 may include a plurality of processors. The processor 52 performs the processes of the search condition acquisition unit 12, the image generation unit 13, the image display unit 14, the control unit 15, the search condition determination unit 16, and the image search unit 17 by loads a computer program(s) from the memory 51 and executes the loaded computer program(s). Note that the thesaurus storage unit 11 is implemented by the memory 51 or a storage device (not shown). Further, the data necessary for the processes such as the data set of images is also stored in the memory 51 or the storage device in advance.

The input device 53 is a device such as a keyboard for receiving an input from a user. The display apparatus 54 is an apparatus such as a display for displaying information.

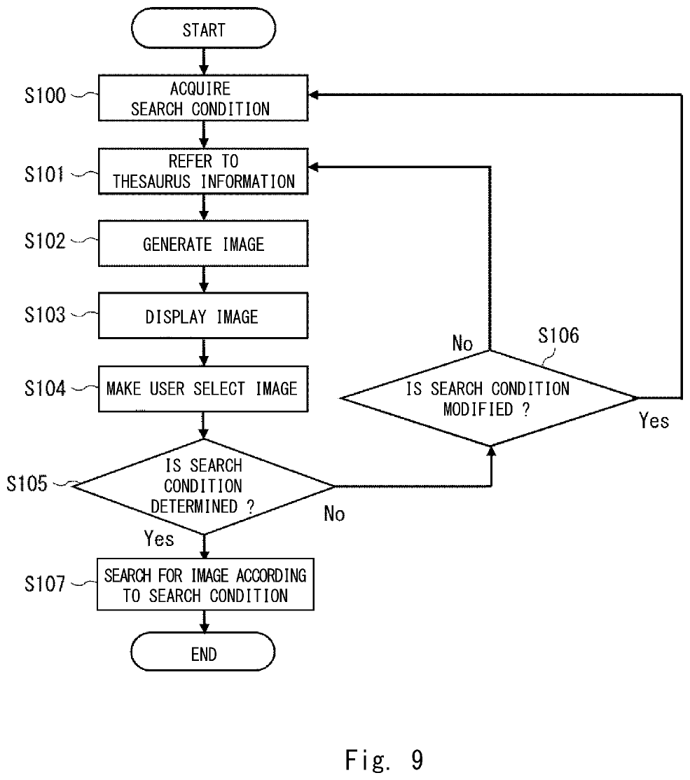

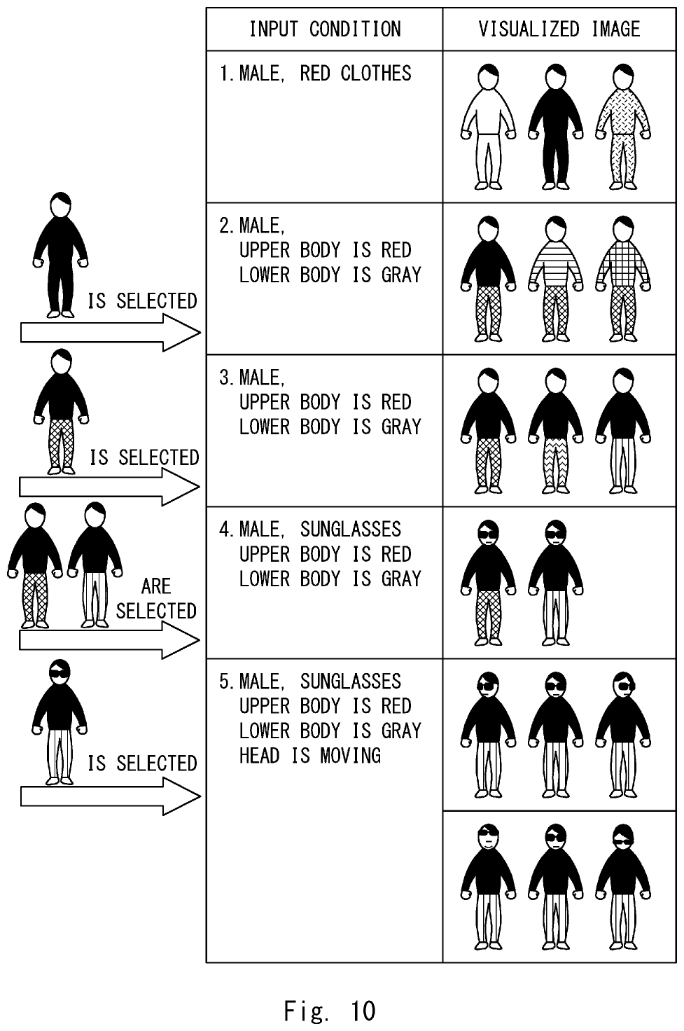

Next, a flow of operations performed by the information processing apparatus 10 will be described. FIG. 9 is a flowchart showing a flow of operations performed by the information processing apparatus 10. The operations performed by the information processing apparatus 10 will be described hereinafter with reference to FIG. 9.

In a step S100, the search condition acquisition unit 12 acquires a search condition(s) input by a user.

Next, in a step S101, the image generation unit 13 refers to thesaurus information and specifies a keyword(s) corresponding to the search condition acquired in the step S100 in the thesaurus information. Further, the image generation unit 13 specifies, as a narrower concept of the aforementioned specified keyword, a keyword(s) defined in the thesaurus information.

Next, in a step S102, the image generation unit 13 generates variation images corresponding to the result of the specification in the step S101.

Next, in a step S103, the image display unit 14 displays the images generated in the step S102 on a display.

Next, in a step S104, the control unit 15 outputs a message for instructing the user to select an image having a content that conforms to the user's intention for the search from among the images displayed in the step S103, and thereby urges the user to select an image. In response to this, the user can modify the search conditions as well as selecting an image, or modify the search conditions without selecting any image.

Next, in a step S105, the control unit 15 determines whether or not an instruction for selecting an image and an instruction for determining search conditions have been received. When these instructions are received, the process proceeds to a step S107. On the other hand, when there is no instruction for determining search conditions, the process proceeds to a step S106. When there is no instruction for determining search conditions, the above-described processes are repeated again. Note that, in this case, the image generation unit 13 may generate new variation images based on the modified search conditions, or may generate new variation images based on the selected image.

In the step S106, the control unit 15 determines whether or not the search conditions have been modified. When the search conditions are modified, the process returns to the step S100 and a search condition(s) is acquired again. That is, in the step S102, an image is generated based on the new search conditions. When the search conditions are not modified, the process returns to the step S101. After that, in the step S102, when new variation images are generated based on the selected image, the image generation unit 13 generates, for example, variation images corresponding to a still narrower concept of the keyword corresponding to the selected image.

In the step S107, the search condition determination unit 16 determines search conditions based on the selected image, and the image search unit 17 searches for an image that meets the search conditions from the data set of images.

As described above, the information processing apparatus 10 displays variation images and receives a user's selection for the variation images. Then, the search conditions are determined according to the selection, and a search is performed by using the search conditions. According to the above-described configuration, it is possible to determine search conditions in which a user's intention is taken into consideration in detail. Therefore, it is possible to provide a search result that conforms to the intention of the user.

In particular, as described above, the information processing apparatus 10 provides a function of modifying the search conditions and a function of displaying an image corresponding thereto. That is, after the image display unit 14 displays images, the search condition acquisition unit 12 newly acquires a search condition(s). Then, the image display unit 14 displays at least one type of an image of the object designated by the newly-acquired search conditions, representing a variation of the object or a variation of the aspect designated by the search conditions for the object. Therefore, it is possible appropriately recognize the user's intention.

Further, the information processing apparatus 10 generates variation images based on the selected image. That is, the image display unit 14 displays at least one type of an image representing a variation of the aspect of the object represented by the image selected according to the instruction received by the control unit 15. Therefore, it is possible to recognize the user's intention in a more detailed manner.

Next, operations performed by the information processing apparatus 10 will be described by using a specific example. FIG. 10 is a schematic diagram showing a flow of an example of a search for an image in which persons are shown. In each of steps shown in FIG. 10, the information processing apparatus 10 acquires a search condition(s) from input text, generates images based on thesaurus information, and shows the generated images to a user.

It is assumed that, in a step 1, “Male, Red clothes” are input as search conditions by the user. The information processing apparatus 10 refers to the thesaurus information in regard to the object shown in FIG. 3 and the thesaurus information in regard to the color shown in FIG. 4, and generates, for example, three types of images representing masculine bodies as described below. A first image is an image showing a man wearing red clothes. A second image is an image showing a man wearing dark-red clothes. A third image is an image showing a man wearing light-coral clothes. The information processing apparatus 10 displays these images and makes the user select an image that conforms to his/her intention for the search. It is assumed that the user has selected the image in which the man is wearing the dark-red clothes. Further, it is assumed that the user, who has seen the displayed image and felt that his/her intention had not been correctly conveyed to the information processing apparatus 10, has changed the search condition “red clothes” to “Upper body is red, and Lower body is gray”.

In a step 2, the information processing apparatus 10 generates new images based on the image selected in the step 1 and the modified search conditions. In this example, three types of images are newly generated. A first image is an image showing a man dressed in dark red on the upper body and in gray on the lower body. A second image is an image showing a man dressed in brown on the upper body and in gray on the lower body. A third image is an image showing a man dressed in firebrick on the upper body and gray on the lower body. The information processing apparatus 10 displays these images and makes the user select an image that conforms to his/her intention for the search. It is assumed that, in response to this, the user has selected the image of the man dressed in dark red on the upper body and in gray on the lower body, and has not changed the search conditions.

In a step 3, the information processing apparatus 10 generates new images based on the image selected in the step 2. The information processing apparatus 10 refers to the thesaurus information in regard to the color shown in FIG. 4, and generates, for example, images described below. A first image is an image showing a man dressed in dark red on the upper body and in gray on the lower body. A second image is an image showing a man dressed in dark red on the upper body and in silver on the lower body. A third image is an image showing a man dressed in dark red on the upper body and in dim gray on the lower body. The information processing apparatus 10 displays these images and makes the user select an image that conforms to his/her intention for the search. It is assumed that, in response to this, the user selects two types of images, i.e., the image of the man dressed in dark red on the upper body and in gray on the lower body and the image of the man dressed in dark red on the upper body and in dim gray on the lower body. Further, it is assumed that the user adds “Sunglass” in the search conditions.

In a step 4, the information processing apparatus 10 generates new images based on the image selected in the step 3 and the added search conditions. In this example, it is assumed that the information processing apparatus 10 has generated images that are obtained by putting sunglasses on the persons in the images selected in the step 3. Note that although the images in which the persons are wearing sunglasses are generated in this example, the information processing apparatus 10 may generate images in each of which a figure representing sunglasses and a figure representing a person are shown side by side. In this example, instead of the images in each of which sunglasses and a person are shown side by side, the images in each of which a person wearing sunglasses is shown are generated according to a predetermined image generation rule. The information processing apparatus 10 displays these images and makes the user select an image that conforms to his/her intention for the search. It is assumed that, in response to this, the user selects the image in which the lower body is dim gray. Further, it is assumed that the user adds a condition “Head is moving” in the search conditions.

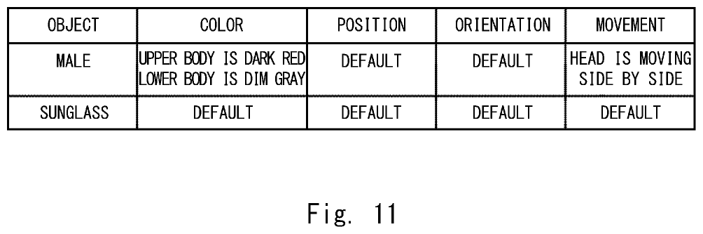

In a step 5, the information processing apparatus 10 generates new images based on the image selected in the step 4 and the added search conditions. For example, the information processing apparatus 10 generates images by referring to the thesaurus information in regard to the movement shown in FIG. 7. As shown in FIG. 7, the “Head moves” has two types of narrower concepts, i.e., “Head moves from side to side” and “Head moves up and down”, so that the information processing apparatus 10 generates images representing these two types of narrower concepts. Note that it is assumed that a movement is represented by a plurality of images. A first set of generated images is a set of images representing a state in which the head moves from side to side. The first set includes, for example, an image in which the head faces to the left, an image in which the head faces the front, and an image in which the head faces to the right. Further, a second set of generated images is a set of images representing a state in which the head moves up and down. The second set includes, for example, an image in which the head faces upward, an image in which the head faces forward, and an image in which the head faces downward. The information processing apparatus 10 displays these two types of sets of images and makes the user select a set of images that conforms to his/her intention for the search. It is assumed that, in response to that, the user selects the first set of images. Then, it is assumed that the user has input an instruction for determining search conditions. In this case, the search condition determination unit 16 determines, for example, the search conditions shown in FIG. 11 as the final search conditions. That is, for example, the search condition determination unit 16 uses the object and the aspects thereof specified by the selected image as the final search conditions. Then, the image search unit 17 searches for an image based on the determined search conditions. In this way, it is possible to perform a search in which the user's intention is taken into consideration more elaborately than in the case where a search is performed by using the search conditions input in the step 1. Note that, in the example shown in FIG. 11, default setting values are used for the search conditions in regard to aspects that have not been designated by the user.

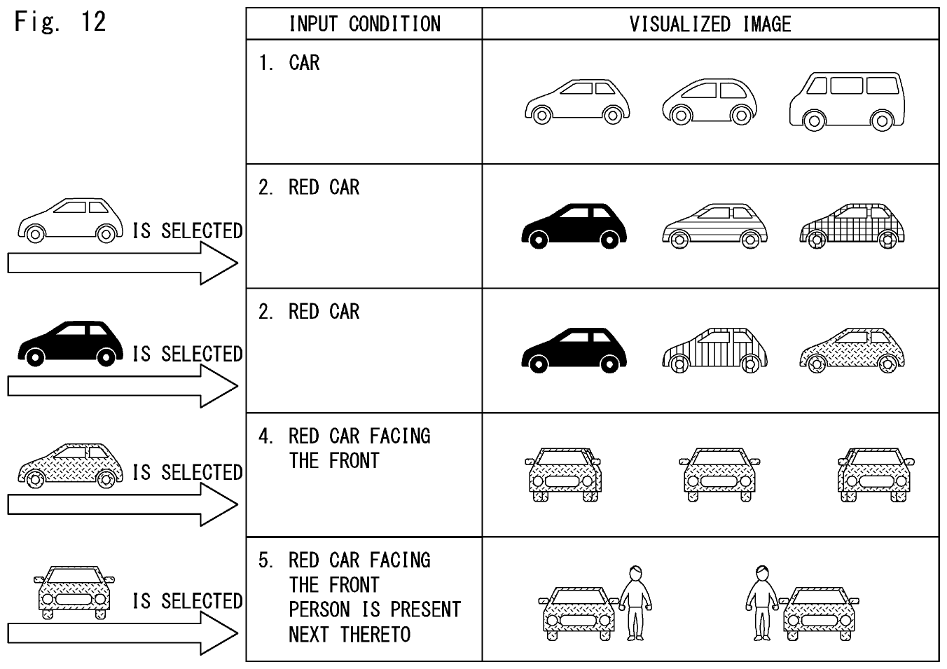

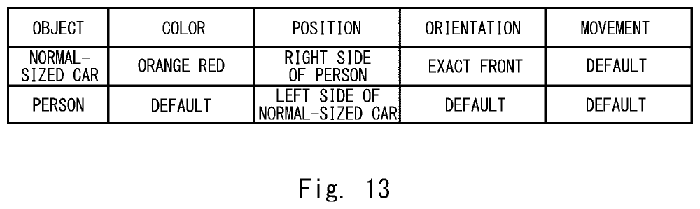

FIG. 12 is a schematic diagram showing a flow of an example of a search for an image in which a car is shown. In each of steps shown in FIG. 12, the information processing apparatus 10 acquires a search condition(s) from input text, generates images based on thesaurus information, and shows the generated images to a user.

It is assumed that, in a step 1, a “car” is input as a search condition from the user. The information processing apparatus 10 refers to the thesaurus information in regard to the object shown in FIG. 3, and generates, for example, three types of images representing cars as described below. A first image is an image of a normal-sized car. A second image is an image of a compact car. A third image is an image of a bus. The information processing apparatus 10 displays these images and makes the user select an image that conforms to his/her intention for the search. It is assumed that the user has selected the image of the normal-sized car. Further, it is assumed that the user, who has seen the displayed image and felt that his/her intention had not been correctly conveyed to the information processing apparatus 10, has changed the search condition to a “Red car”.

In a step 2, the information processing apparatus 10 generates new images based on the image selected in the step 1 and the modified search conditions. In this example, it is assumed that the information processing apparatus 10 has referred to the thesaurus information in regard to the color shown in FIG. 4, and newly generated, for example, three types of images described below. A first image is an image of a red normal-sized car. A second image is an image of a dark-red normal-sized car. A third is an image of a light-coral normal-sized car. The information processing apparatus 10 displays these images and makes the user select an image that conforms to his/her intention for the search. It is assumed that, in response to that, the user has selected the image of the red normal-sized car, and has not changed the search conditions.

In a step 3, the information processing apparatus 10 generates new images based on the image selected in the step 2. The information processing apparatus 10 refers to the thesaurus information in regard to the color shown in FIG. 4, and generates, for example, images described below. A first image is an image of a red normal-sized car. A second image is an image of a crimson normal-sized car. A third image is an image of an orange-red normal-sized car. The information processing apparatus 10 displays these images and makes the user select an image that conforms to his/her intention for the search. It is assumed that, in response to that, the user has selected the image of the orange-red normal-sized car, and has modified the search condition to a “Red car facing the front”.

In a step 4, the information processing apparatus 10 generates new images based on the image of the car selected in the step 3 and the added search conditions. In this example, it is assumed that the information processing apparatus 10 has referred to the thesaurus information in regard to the orientation shown in FIG. 5, and generates, for example, three types of images described below. A first image is an image of an orange-red normal-sized car in a state in which although the front of the car is seen, a left side thereof is also slightly seen, rather than the exact front of the car being seen. A second image is an image of an orange-red normal-sized car of which the exact front is seen. A third image is an image of an orange-red normal-sized car in a state in which although the front of the car is seen, a right side thereof is also slightly seen, rather than the exact front of the car being seen. The information processing apparatus 10 displays these images and makes the user select an image that conforms to his/her intention for the search. It is assumed that, in response to that, the user has selected the image of the orange-red normal-sized car of which the exact front is seen. Further, it is assumed that the user adds a condition “Person is present next thereto” in the search conditions.

In a step 5, the information processing apparatus 10 generates new images based on the image selected in the step 4 and the added search conditions. In this example, it is assumed that the information processing apparatus 10 has referred to the thesaurus information in regard to the position shown in FIG. 5, and generates, for example, two types of images described below. That is, it is assumed that the information processing apparatus 10 has generated two types of images described below based on “Left” and “Right” which are narrower concepts of the “Next”. A first image is an image in which a person is added on the left side of the car selected in the step 4. A second image is an image in which a person is added on the right side of the car selected in the step 4. The information processing apparatus 10 displays these images and makes the user select an image that conforms to his/her intention for the search. It is assumed that, in response to this, the user has selected the image in which the person is added on the left side of the car. Then, it is assumed that the user has input an instruction for determining search conditions. In this case, the search condition determination unit 16 determines, for example, the search conditions shown in FIG. 13 as the final search conditions. That is, for example, the search condition determination unit 16 uses the object and the aspects thereof specified by the selected image as the final search conditions. Then, the image search unit 17 searches for an image based on the determined search conditions. In this way, it is possible to perform a search in which the user's intention is taken into consideration more elaborately than in the case where a search is performed by using the search conditions input in the step 1. Note that, in the example shown in FIG. 13, default setting values are used for the search conditions in regard to aspects that have not been designated by the user.

Note that the present invention is not limited to the above-described example embodiments, and they may be modified as appropriate without departing from the scope and spirit thereof. For example, although the color, the position, the orientation, and the movement are used as examples of the aspects for generating variation images in the above-described example embodiment, aspects other than these examples may be used.

Further, the whole or part of the example embodiments disclosed above can be described as, but not limited to, the following supplementary notes.

### (Supplementary Note 1)

An information processing apparatus comprising:

search condition acquisition means for acquiring an input search condition;

image display means for displaying at least one type of an image of an object designated by the search condition acquired by the search condition acquisition means, the at least one type of the image representing a variation of the object or a variation of an aspect designated by the search condition for the object;

selection receiving means for receiving an instruction for selecting at least one type of an image from among the images displayed by the image display means; and

search condition determination means for determining a search condition based on the image selected according to the instruction received by the selection receiving means.

### (Supplementary Note 2)

The information processing apparatus described in Supplementary note 1, wherein

the search condition acquisition means newly acquires a search condition after the image is displayed by the image display means, and

the image display means displays at least one type of an image of the object designated by the newly-acquired search condition, the at least one type of the image representing a variation of the object or a variation of the aspect designated by the search condition for the object.

### (Supplementary Note 3)

The information processing apparatus described in Supplementary note 1 or 2, wherein the image display means displays at least one type of an image representing a variation of the aspect of the object represented by the image selected according to the instruction received by the selection receiving means.

### (Supplementary Note 4)

The information processing apparatus according to any one of Supplementary notes 1 to 3, wherein the image display means determines a priority order of the display of images according to the order of designation of objects or aspects in the search condition acquired by the search condition acquisition means.

(Supplementary Note 5) The information processing apparatus according to any one of

Supplementary notes 1 to 4, wherein one of the aspects is a color of the object.

### (Supplementary Note 6)

The information processing apparatus according to any one of Supplementary notes 1 to 5, wherein one of the aspects is a position of the object in the image.

(Supplementary note 7)

The information processing apparatus according to any one of Supplementary notes 1 to 6, wherein one of the aspects is an orientation of the object.

(Supplementary note 8)

The information processing apparatus according to any one of Supplementary notes 1 to 7, wherein the aspect is a movement of the object.

(Supplementary note 9)

The information processing apparatus according to any one of Supplementary notes 1 to 8, further comprising image search means for searching for an image that meets the search condition determined by the search condition determination means according to the search condition.

(Supplementary note 10)

A search method comprising:

acquiring an input search condition;

displaying at least one type of an image of an object designated by the acquired search condition, the at least one type of the image representing a variation of the object or a variation of an aspect designated by the search condition for the object;

receiving an instruction for selecting at least one type of an image from among the displayed images; and

determining a search condition based on the image selected according to the received instruction.

### (Supplementary Note 11)

A non-transitory computer readable medium storing a program for causing a computer to perform:

a search condition acquisition step of acquiring an input search condition;

an image display step of displaying at least one type of an image of an object designated by the acquired search condition, the at least one type of the image representing a variation of the object or a variation of an aspect designated by the search condition for the object;

a selection receiving step of receiving an instruction for selecting at least one type of an image from among the displayed images; and

a search condition determination step of determining a search condition based on the image selected according to the received instruction.

Although the present invention is explained above with reference to example embodiments, the present invention is not limited to the above-described example embodiments.

Various modifications that can be understood by those skilled in the art can be made to the configuration and details of the present invention within the scope of the invention.

This application is based upon and claims the benefit of priority from Japanese patent applications No. 2019-053045, filed on Mar. 20, 2019, the disclosure of which is incorporated herein in its entirety by reference.

### REFERENCE SIGNS LIST

1 INFORMATION PROCESSING APPARATUS
2 SEARCH CONDITION ACQUISITION UNIT
3 IMAGE DISPLAY UNIT
4 SELECTION RECEIVING UNIT
5 SEARCH CONDITION DETERMINATION UNIT
10 INFORMATION PROCESSING APPARATUS
11 THESAURUS STORAGE UNIT
12 SEARCH CONDITION ACQUISITION UNIT
13 IMAGE GENERATION UNIT
14 IMAGE DISPLAY UNIT
15 CONTROL UNIT
16 SEARCH CONDITION DETERMINATION UNIT
17 IMAGE SEARCH UNIT
50 NETWORK INTERFACE
51 MEMORY
52 PROCESSOR
53 INPUT APPARATUS
54 DISPLAY APPARATUS

What is claimed is:

1. An information processing apparatus comprising:
at least one memory storing instructions; and
at least one processor configured to execute the instructions stored in the memory to:
acquire an input search condition;
display at least one type of an image of an object designated by the acquired search condition, the at least one type of the image representing a variation of the object or a variation of an aspect designated by the search condition for the object;
receive an instruction for selecting at least one type of an image from among the displayed images; and
determine a search condition based on the image selected according to the received instruction.

2. The information processing apparatus according to claim 1, wherein
the processor is configured to execute the instructions to:
newly acquire a search condition after the image is displayed, and
display at least one type of an image of the object designated by the newly-acquired search condition, the at least one type of the image representing a variation of the object or a variation of the aspect designated by the search condition for the object.

3. The information processing apparatus according to claim 1, wherein the processor is configured to execute the instructions to display at least one type of an image representing a variation of the aspect of the object represented by the image selected according to the received instruction.

4. The information processing apparatus according to claim 1, wherein the processor is configured to execute the instructions to determine a priority order of the display of images according to the order of designation of objects or aspects in the acquired search condition.

5. The information processing apparatus according to claim 1, wherein one of the aspects is a color of the object.

6. The information processing apparatus according to claim 1, wherein one of the aspects is a position of the object in the image.

7. The information processing apparatus according to claim 1, wherein one of the aspects is an orientation of the object.

8. The information processing apparatus according to claim 1, wherein the aspect is a movement of the object.

9. The information processing apparatus according to claim 1, wherein the processor is further configured to execute the instructions to search for an image that meets determined the search condition.

10. A search method comprising:
acquiring an input search condition;
displaying at least one type of an image of an object designated by the acquired search condition, the at least one type of the image representing a variation of the object or a variation of an aspect designated by the search condition for the object;
receiving an instruction for selecting at least one type of an image from among the displayed images; and
determining a search condition based on the image selected according to the received instruction.

11. A non-transitory computer readable medium storing a program for causing a computer to perform:
a search condition acquisition step of acquiring an input search condition;
an image display step of displaying at least one type of an image of an object designated by the acquired search condition, the at least one type of the image representing a variation of the object or a variation of an aspect designated by the search condition for the object;
a selection receiving step of receiving an instruction for selecting at least one type of an image from among the displayed images; and
a search condition determination step of determining a search condition based on the image selected according to the received instruction.
